(19) United States
(12) Patent Application Publication
(10) Pub. No.: US 2024/0286222 A1
(43) Pub. Date: Aug. 29, 2024

(54) CLOSED LOOP CONTROL OF AN ACTIVE PROCESSING AREA IN ADDITIVE MANUFACTURING

(71) Applicant: FORMALLOY TECHNOLOGIES, INC., Spring Valley, CA (US)

(72) Inventors: Jeffrey L. RIEMANN, Spring Valley, CA (US); Kurt R. Moran, Spring Valley, CA (US)

(21) Appl. No.: 18/114,144

(22) Filed: Feb. 24, 2023

(51) Int. Cl. B23K 26/342; B22F 10/28; B22F 10/36; B22F 10/85; B23K 26/03; B33Y 10/00; B33Y 30/00; B33Y 50/02

(52) U.S. Cl. CPC B23K 26/342; B22F 10/28; B22F 10/36; B22F 10/85; B23K 26/034; B33Y 10/00; B33Y 30/00; B33Y 50/02; B22F 2203/11

(57) ABSTRACT

Additive manufacturing systems and methods are described, including a method of operating an additive manufacturing system, including: determining, by processing streaming image data, at least two characteristics of an active processing area while depositing a layer of a part being additively manufactured; and performing closed loop control of at least two processing parameters of the additive manufacturing system in order to modify the at least two characteristics of the active processing area while depositing the layer of the part being additively manufactured.

### INTRODUCTION

The present disclosure relates to additive manufacturing systems and methods. In particular, aspects of the present disclosure relate to systems and methods for controlling characteristics of an active processing area, such as a melt pool, during an additive manufacturing process.

Examples of commercially available additive manufacturing methods include extrusion-based methods (e.g., Fused Deposition Modeling (FDM)), fusing or binding from a powder bed based methods (e.g., Selective Laser Sintering (SLS), Selective Laser Melting (SLM), and Electron Beam Melting (EBM)), lamination methods, photopolymerization methods (e.g., stereo lithography), powder-or wire-fed directed energy deposition methods (e.g., direct metal deposition (DMD), laser additive manufacturing (LAM), laser metal deposition (LMD)), and others.

Laser metal deposition (LMD) is a laser-based additive manufacturing process in which metal structures are built up on a substrate or applied to existing articles (e.g., cladding). In LMD, metal powder or wire is directed towards a laser that melts the powder or wire and forms a melt pool (e.g., an area of molten metal) that bonds with the underlying surface thereby forming new layers and ultimately structures additively. A melt pool is an example of an active processing area.

A challenge with laser metal deposition is properly maintaining consistent and desired characteristics of the melt pool, such as its height (or thickness), width, length, roundness, etc. For example, too wide a melt pool may cause a deposited layer to be too short or to conflict with other layers.

One indirect method of controlling characteristics of the melt pool is to precisely control the distance between a deposition element of an additive manufacturing machine and an active processing area on a build surface, such as a substrate or part layer upon which new material is being deposited, which may be referred to as controlling the working distance. When the working distance diverges from the optimum, the build quality of the additive manufacturing process may suffer due to, for example, irregular layer height, wasted material, uneven heating, and the like. As described in U.S. patent application Ser. No. 17/094,611, entitled “Working Distance Measurement for Additive Manufacturing,” filed Nov. 10, 2020, the distance between the deposition head and the build surface be carefully maintained during an additive manufacturing process so that a focal point of a directed energy beam, a focal point of a powder flow, and a build surface all converge in a desired way to form a desired melt pool.

While actively controlling the working distance between a deposition element and a build surface is one effective method for controlling build quality, it is nevertheless an indirect method. Further, that method alone does not leverage other operational settings that might be used to more precisely control the characteristics of the melt pool.

Accordingly, what is needed are improved systems and methods for actively controlling characteristics of an active processing area, such as a melt pool, during additive manufacturing.

### BRIEF SUMMARY

A first aspect provides a method operating an additive manufacturing system, comprising: determining, by processing streaming image data, at least two characteristics of an active processing area while depositing a layer of a part being additively manufactured; and performing closed loop control of at least two processing parameters of the additive manufacturing system in order to modify the at least two characteristics of the active processing area while depositing the layer of the part being additively manufactured.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; computer program products embodied on computer-readable storage media comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more embodiments and are therefore not to be considered limiting of the scope of this disclosure.

FIG. 1 depicts an example of an additive manufacturing system.

FIG. 2 depicts an example of a material delivery system.

FIG. 3 depicts an example of an additive manufacturing machine with an active processing area monitoring system.

FIG. 4 depicts another example of an active processing area monitoring system.

FIGS. 5A and 5B depict example views of an active processing area that may be used for determining characteristics of the active processing area for closed loop control.

FIG. 6 depicts aspects of control system configured for performing closed loop control of an additive manufacturing process.

FIG. 7 depicts an example method of operating an additive manufacturing system with a closed loop control system.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for actively controlling characteristics of an active processing area, such as a melt pool, during additive manufacturing using closed loop control.

Maintaining desired characteristics of an active processing area (e.g., the melt pool created by laser metal deposition) is an important aspect to improving the quality of a part being built by an additive manufacturing system. In some aspects, an active processing area, such as a melt pool, may be a generally spheroid type shape having various characteristics, such as length, width, height, roundness or circularity, symmetry, center of mass, centroid location, area, volume, centroid, elliptic major axis, elliptic minor axis, elliptic ratio, rectangle width, rectangle height, rectangle location, perimeter, fitted rectangle major axis, fitted rectangle minor axis, inscribed circle radius, circumference circle radius, flatness, number of holes, temperature, temperature gradient, cooling rate, and others. Note that as used herein when describing a layer or an active processing area, height is generally a measurement with reference to a vertical axis (e.g., Z-axis) normal to a build plane, while width and length are measurements with reference to axes (e.g., X and Y) parallel to the build plane.

Unlike previous methods, which rely on indirect measurements of the active processing area to control the additive manufacturing process, embodiments described herein improve upon the state of the art by monitoring the active processing area directly with various types of sensors, including image sensors, and determining characteristics of the active processing area with which to perform closed loop control of the additive manufacturing process. For example, measuring a distance between a deposition nozzle and a build surface may suggest a resulting layer height, but the relationship between the distance and the resulting layer height may be undone by any change to the additive manufacturing machine, such as a change in deposition nozzle. Beneficially, closed loop control avoids this issue and allows for an additive manufacturing apparatus to maintain target values for active processing area characteristics (e.g., height, width, temperature, etc.). The closed loop control process beneficially results in improved build quality and less reliance on the initial instructions or coding for a build process, such as the original G-code generated by a part slicing program, as well as the configuration of the additive manufacturing machine (e.g., which nozzle is in use).

Further, closed loop control of the additive manufacturing process beneficially generates data (e.g., operational setting log data) that can be used for improving the original build instructions (e.g., G-code) as well as to train machine learning models for improving the build process, such as by more accurately adjusting operational settings to achieve desired characteristics.

### Example Additive Manufacturing System

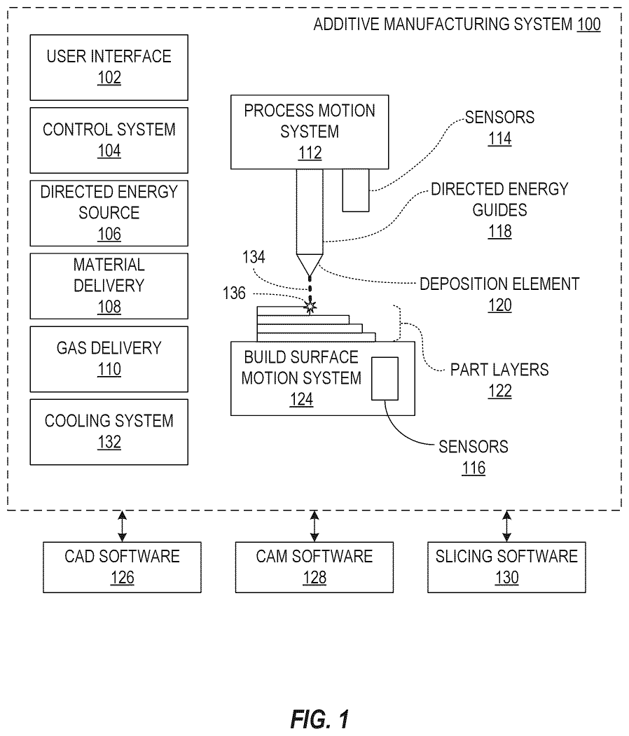

FIG. 1 depicts an example of an additive manufacturing system 100.

In this example, additive manufacturing system 100 includes a user interface 102. User interface 102 may be, for example, a graphical user interface comprising hardware and software controls for controlling additive manufacturing system 100. In some examples, user interface 102 may be integral with additive manufacturing system 100, while in other examples, user interface 102 may be remote from additive manufacturing system 100 (e.g., on a remote computer such as a server computer, desktop or laptop computer, or a personal electronic device, such as a smartphone, tablet computer, or a smart wearable device, to name a few examples).

Additive manufacturing system 100 also includes a control system 104. In this example, control system 104 is in data communication with user interface 102 as well as directed energy source 106, material delivery system 108, gas delivery system 110, process motion system 112, sensors 114, sensors 116, build surface motion system 124, and cooling system 132. In other examples, control system 104 may be in data communication with further elements of additive manufacturing system 100, which are not depicted in this example. Further, in other examples, control system 104 may be in data communication with fewer elements of additive manufacturing system 100, such as where another embodiment of an additive manufacturing system includes fewer elements compared to the example of FIG. 1.

Control system 104 may include hardware and software for controlling various aspects of additive manufacturing system 100. For example, control system 104 may include one or more processors, memories, data storages, physical interfaces, software interfaces, software programs, firmware, and other aspects in order to coordinate and control the various elements of additive manufacturing system 100. In some examples, control system 104 may include network connectivity to various aspects of additive manufacturing system 100 as well as to external networks, such as the Internet and other networks, such as personal area networks (PANs), local area networks (LANs), and wide area networks (WANs). In some examples, control system 104 may be a purpose-built logic board, microcontroller, field programmable gate array (FPGA), or the like, while in other examples control system 104 may be implemented by a general purpose computer with specific software components for controlling the various aspects of additive manufacturing system 100.

Control system 104 may generally interpret commands received from user interface 102 (or elsewhere) and thereafter cause appropriate control signals to be transmitted to other aspects of additive manufacturing system 100. For example, a user may input data into user interface 102 representing a part to be processed by additive manufacturing system 100 and control system 104 may act upon that input to cause additive manufacturing system 100 to process the part.

In some examples, control system 104 may compile and execute machine control codes, such as G-code data, that causes aspects of additive manufacturing system 100 to operate. For example, the machine control codes may cause process motion system 112 and/or build surface motion system 124 to move to specific positions and at specific speeds. As another example, the machine control codes may cause directed energy source 106, material delivery system 108, gas delivery system 110, and/or cooling system 132 to activate or deactivate at specific times, locations, or based on specific conditions, such as operating conditions, sensor readings, and the like. Further, the machine control codes may modulate the operation (e.g., via an operational setting or parameter) of the aforementioned aspects of additive manufacturing system 100, such as by increasing or decreasing the power of directed energy source 106, increasing or decreasing the flow rate of material delivery system 108 or gas delivery system 110, increasing or decreasing an amount of cooling by cooling system 132, increasing or decreasing the speed of process motion system 112 and/or build surface motion system 124, etc., based on time, location, and/or conditions, such as operating conditions, sensor readings, and the like.

Process motion system 112 may move elements of additive manufacturing system 100 to specified positions. For example, process motion system 112 may position deposition element 120 at a specified distance from a part layer 122 being manufactured, or move deposition element 120 along a preprogrammed path to deposit material and thereby build up a three-dimensional part.

Additive manufacturing system 100 may include various sensors to monitor and to help control aspects of a manufacturing process through active feedback. In some embodiments, sensors 114 may be connected to process motion system 112 such that the sensors are configured to move with process motion system 112. For example, sensors 114 may include one or more temperature sensors, distance sensors, optical sensors (e.g., camera or video sensors), each of which may be configured to provide operational data during processing by additive manufacturing system 100. For example, temperature sensors may provide point temperature measurements, temperature gradients, heat maps, etc.

In some embodiments, a temperature sensor of sensors 114 may be any sort of sensor capable of measuring temperature to an object. In some examples, the temperature sensor may include a contact-based sensor, such as a thermocouple, while in others, the temperature sensor may be a contact-less sensor, such as an image or laser-based sensor, or other type of pyrometer. One or more temperature sensors may provide various types of temperature data back to control system 104, for example, to provide data for control of directed energy source 106, gas delivery system 110, and cooling system 132 to enable closed loop control of directed actively cooled gas flows.

In some embodiments, sensors 114 may include various forms of optical sensors (e.g., image and/or camera sensors), such as a visible spectrum optical sensor, or a non-visible spectrum (e.g., infrared) optical sensor. In some examples, the same sensor may be able to provide data in multiple spectrums. Further, additive manufacturing system 100 may include optics that allow for directing, changing (e.g., zooming), and focusing a field of view of an optical sensor. Optical sensors may generally provide various types of image data, including infrared heat data, back to control system 104, for example, to provide data for control of directed energy source 106, gas delivery system 110, and cooling system 132 to enable closed loop control of various aspects of additive manufacturing system 100. For example, an infrared-based optical sensor (e.g., an infrared image sensor) may be used to view heat distributions and gradients in part layers 122.

In some embodiments, various sensors, such as image sensors and contactless temperature and distance sensors, may be configured to have coaxial “views” of an active processing area 136, such as a melt pool created by deposition element 120. For example, a boresight camera or other sensor may be configured with optics that allow for “looking” down the directed energy axis (e.g., axis of directed energy beam 134) towards the part being manufactured, such as by using turning mirrors, one-way mirrors, and other optical elements.

Directed energy source 106 may provide any suitable form of directed energy, such as a laser beam (e.g., from a fiber laser) or an electron beam generator, which is capable of melting a manufacturing material, such as a metal powder. Directed energy source 106 may interact with directed energy guides 118 in order to, for example, direct or focus a particular type of directed energy. For example, directed energy guides 118 may comprise one or more optical elements, such as mirrors, lenses, filters, and the like, configured to focus a directed energy beam (e.g., laser beam) at a specific focal point (e.g., active processing area 136) and to control the size of the focal point. In this way, the actual creation of the directed energy beam by directed energy source 106 may be located away from other components that manipulate and focus the directed energy by directed energy guides 118.

In some embodiments, directed energy source 106 may also be used to remove material from a manufactured part, such as by ablation.

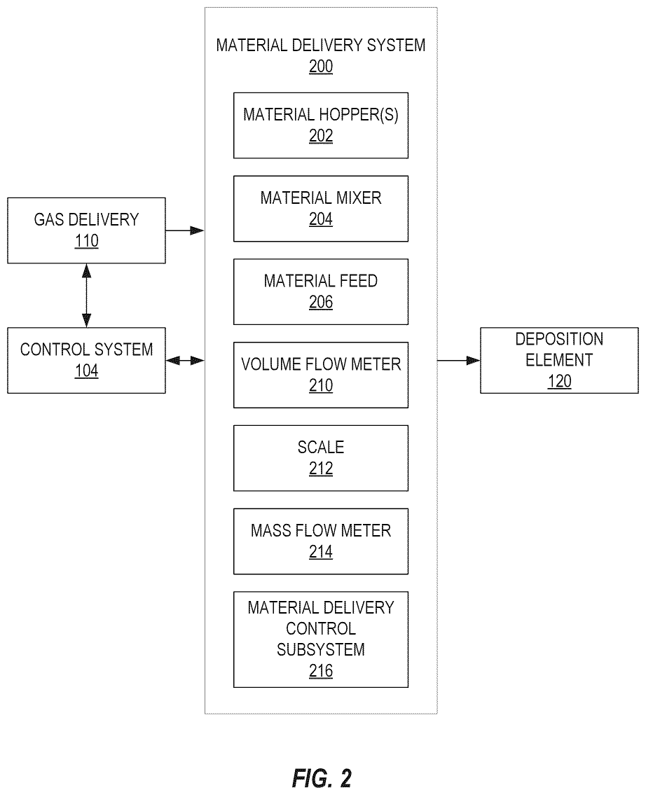

Material delivery system 108 is generally configured to supply building material, such as powder or wire, to deposition element 120 and ultimately to active processing area 136. In some examples, material delivery system 108 may be a remote reservoir including one or more types of raw material (e.g., different types of metal powder or wire) to be used by additive manufacturing system 100. Material delivery system 108 may be configured to provide one or more materials simultaneously to deposition element 120, such that hybrid materials (e.g., metal alloys) may be created in part layers 122 (or portions thereof). FIG. 2 describes an example of a material delivery system that may be used with additive manufacturing system 100.

Deposition element 120 may be connected with material delivery system 108 and may direct material, such as powder or wire, towards a focal point of directed energy beam 134. In this way, material delivery system 108 may help control the amount of material that is added to a build surface. Deposition element 120 may include nozzles, apertures, and other features for directing material, such as powder and wire, towards active processing area 136. In some examples, deposition element 120 may have controllable characteristics, such as controllable nozzle aperture sizes. In some embodiments, deposition element 120 may be a nozzle assembly or deposition head of a laser metal deposition machine.

Gas delivery system 110 may be connected with deposition element 120 to provide propulsive force to the material provided by material delivery system 108, such as by use of carrier gas. In some examples, gas delivery system 110 may modulate the gas flow rate to control material (e.g., powder) flow through deposition element 120 and/or to provide cooling effect during the manufacturing process.

Gas delivery system 110 may include feeds for a plurality of gas flows, such as carrier gas (as described above) as well as shield gas and auxiliary gas flows, such as directed actively cooled gas flows. Gas delivery system 110 may also include feeds for different types of gases so that, for example, different gases may be used for carrier gases, shield gases, and auxiliary gases. Gas delivery system 110 may further be configured to provide different gas flows at different rates under the control of control system 104.

Gas delivery system 110 may also be connected with cooling system 132, which may actively cool any of the gas aforementioned gas flows (e.g., carrier, shield, and auxiliary). Cooling system 132 may be configured to apply different amounts of cooling to different gases under the control of control system 104.

Notably, while directed energy source 106, material delivery system 108, gas delivery system 110, sensors 114, sensors 116, directed energy guides 118, and deposition element 120 are shown in an example configuration in FIG. 1, other configurations are possible.

Process motion system 112 may control the positioning of one or more aspects of additive manufacturing system 100, such as sensors 114, sensors 116, and deposition element 120. In some examples, process motion system 112 may be movable in one or more degrees of freedom (e.g., three to six degrees of freedom). For example, process motion system 112 may move and rotate deposition element 120 in and about the X, Y, and Z axes during the manufacturing of part layers 122.

Though not depicted, in various embodiments, process motion system 112 may include cooling elements, such as cooling tubes, fins, channels, lines, and the like. In some embodiments, cooling system 132 may be configured to actively control the temperature of (e.g., to cool) process motion system 112, or parts thereof, such as sensors 114.

Build surface motion system 124 may control the positioning of, for example, a build surface upon which part layers 122 are manufactured. In some examples, build surface motion system 124 may be movable in and about one or more degrees of freedom. For example, build surface motion system 124 may move and rotate the build surface in and about the X, Y, and Z axes during the manufacturing of part layers 122. In some examples, the build surface may be referred to as a build plate or build substrate.

Build surface motion system 124 may also comprise sensors 116, which may include, for example, load sensors, temperature sensors, position sensors, and other sensors that may provide useful information to control system 104. For example, a temperature sensor within build surface motion system may cause control system 104 to increase cooling via cooling system 132, or to decrease power to a directed energy source, and the like.

Though not depicted, in various embodiments, build surface motion system 124 may include cooling elements, such as cooling tubes, fins, channels, and the like. In some embodiments, cooling system 132 may be configured to actively control the temperature of (e.g., to cool) build surface motion system 124, or parts thereof, such as a substrate of build surface motion system 124.

Cooling system 132 may be any sort of active cooling system, such as refrigeration system, a vortex cooler, evaporative gas cooling system, heat pump, and others. Active cooling generally refers to taking an input coolant medium (e.g., fluid or gas) and extracting heat from that coolant medium such that the output coolant medium has a lowered temperature.

Computer-Aided Design (CAD) software 126 may be used to design a digital representation of a part to be manufactured, such as a 3D model. CAD software 126 may be used to create 3D design models in standard data formats, such as DXF, STP, IGS, STL, and others. While shown separate from additive manufacturing system 100 in FIG. 1, in some examples CAD software 126 may be integrated with additive manufacturing system 100.

Slicing software 130 may be used to “slice” a 3D design model into a plurality of slices or design layers. Such slices or design layers may be used for the layer-by-layer additive manufacturing of parts using, for example, additive manufacturing system 100. Further, slicing software 130 may be used to generate rotary toolpaths. For example, in a rotary toolpath, a deposition element may move in the Z axis such that over the course of a full rotation the Z axis will have moved up the equivalent of one layer height.

Computer-Aided Manufacturing (CAM) software 128 may be used to create machine control codes, for example, G-Code, for the control of additive manufacturing system 100. For example, CAM software 128 may create code in order to direct additive manufacturing system 100 to deposit a material layer along a 2D plane, such as a build surface, in order to build or process a part. For example, as shown in FIG. 1, part layers 122 are manufactured on (e.g., deposited on, formed on, processed on, etc.) build surface motion system 124 using process motion system 112 and deposition element 120.

In some examples, one or more of CAD software 126, CAM software 128, and Slicing Software 130 may be combined into a single piece or suite of software. For example, CAD or CAM software may have an integrated slicing function.

### Example Material Delivery Subsystem

FIG. 2 depicts an example of a material delivery system 200. For example, material delivery subsystem 200 may be an example of material delivery system 108 in FIG. 1.

Material delivery system 200 comprises one or more material hoppers 202 having corresponding hopper outputs to contain and continuously feed material, such as powdered build materials (e.g., metal powders), to a downstream portion of an additive manufacturing system, such as to deposition element 120. In some embodiments, material hopper 202 is a pressurized material hopper that is connected to gas delivery system 110, such as described with respect to FIG. 1. Any suitable number of material hoppers 202 may be used in material delivery system 200 and each may include the same or a different powder than each of the other material hoppers. Any suitable material may be utilized, such as a metal powder, a ceramic powder, or metal matrix composite powder, to name just a few.

Material delivery system 200 may also include a material mixer 204. For example, where multiple material hoppers 202 are used to create mixed materials for deposition, material mixer 204 may be used to improve the consistency of the material mixture. For example, material mixer 204 may comprise a stir mixer or a vibratory mechanism to maintain flow consistency.

Material delivery systems 200 may also include a material feed 206 configured to control the flow of material from material hopper 202 (or material mixer 204) to downstream portions of an additive manufacturing apparatus, such to deposition element 120. Material feed 206 may be of any suitable type, such as a gravity fed feeder, pressurized feeder, disc-type feeder, vibratory feeder, or screw-fed feeder so long as the material may be satisfactorily contained and continuously fed to the downstream portion of an additive manufacturing system.

Material delivery systems 200 may also include a volume flow meter 210 configured to measure the volume of material flow from material delivery system 200 to downstream portions of an additive manufacturing device, such as to deposition element 120.

In one embodiment, volume flow meter 210 comprises an optical material flow meter configured to determine a volumetric feeding rate of material from material delivery system 200. Generally, an optical material flow meter may include a collimated and/or expanded light (e.g., laser light) beam and an optical sensor configured to detect the light. In some embodiments, the light beam is directed through a material flow towards the optical sensor such that a density of the material flowing through the system scatters the light beam and changes the amount of light impinging on the optical sensor. The amount of light received by the optical sensor thus decreases or increases as the material flow increases or decreases. In some embodiments, the optical sensor is configured to output a voltage based on the amount of light received by the optical sensor. The volumetric feeding rate of the material may be determined from the voltage output of optical sensor through, for example, a calibration process.

Material delivery systems 200 may also include a mass flow meter 214 configured to measure the mass of material flow to, for example, deposition element 120. For example, in one embodiment, mass flow meter 214 converts an analog (e.g., voltage) output from scale 212 and determines a corresponding mass-flow rate. In another embodiment, the output from scale 212 may be a digital signal.

In an alternative embodiment, scale 212 may output an analog or digital signal directly to material delivery control subsystem 216 or to control system 104, either of which may, in-turn, calculate the mass flow rate based on the output signal from scale 212.

Material delivery systems 200 may also include a material delivery control subsystem 216 in some embodiments. In such embodiments, material delivery control subsystem 216 may interface with local elements of material delivery system 200 and provide a data and control link to overall control system 104. In some embodiments, a standard data protocol may be implemented between control system 104 and material delivery control subsystem 216. In this way, material delivery system 200 may be a modular component able to be added to any additive manufacturing system, including additive manufacturing system 100 described with respect to FIG. 1, with minimal changes to the existing additive manufacturing system. For example, an existing additive manufacturing system may only need to implement instructions (e.g., consistent with an established machine control protocol) for material delivery system 200 without needing special programming (e.g., machine-level instructions) to interoperate with material delivery system 200.

However, in other embodiments, material delivery control subsystem 216 may be omitted, and control of material delivery system 200 may be implemented in control system 104.

In either control architecture, material feed 206 may be controlled based on feedback from flow meters, such as volume flow meter 210 and/or mass flow meter 214. For example, a proportional-integral-derivative (PID) control loop may be implemented to increase or decrease a material feed rate via material feed 206 in order to provide a constant material mass flow to downstream elements of the additive manufacturing process, such as deposition element 120.

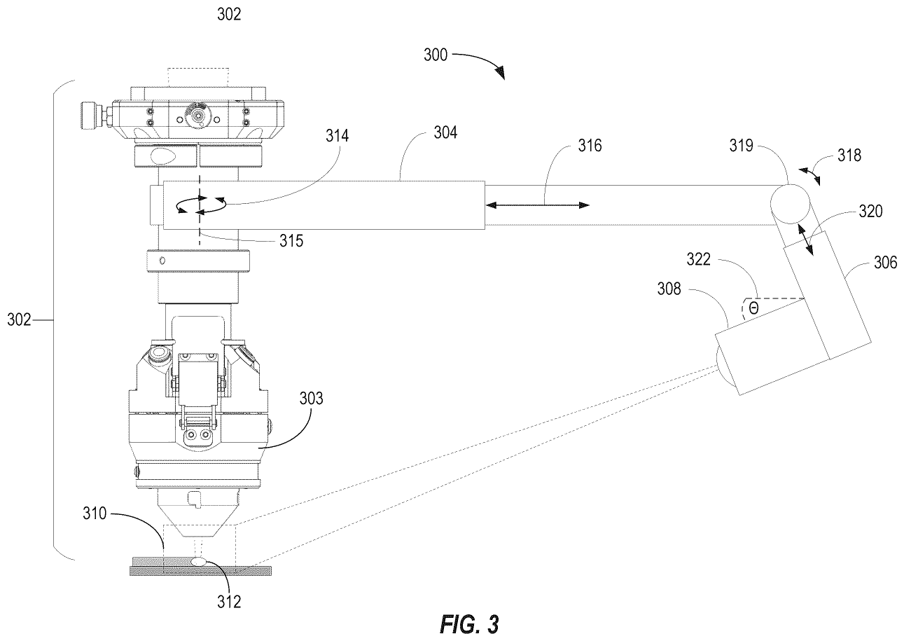

With the inclusion of a very accurate scale 212, such as a SAW scale, material delivery system 200 is able to accurately measure mass flow based on changes in measured weight over time, rather than by deriving the mass flow based on volume flow measurements (e.g., from volume flow meter 210) and assumptions regarding the weight per unit volume of the flowing material. For example, as described in more detail below with respect to FIG. 3, the PID control scheme may control the speed of a disc-based material feeder in order to control the mass flow rate.

In some embodiments, one of the flow meters, such as the mass flow meter 214, may be used as a primary flow control signal (or data) source, while the other flow meter, which in this example is volume flow meter 210, may be used as a check for system redundancy. In other embodiments, both mass flow meter 214 and volume flow meter 210 may be used as flow control signals. In some cases, divergence or differences between the flow measurement types (e.g., volume-based mass approximation) and mass flow may indicate a fault in the system (such as a clogged feed line) that should be checked before additional manufacturing. Further, changes in mass flow rate may be used to notify a user that a material feeder (e.g., material hopper 202) is low or has run out and needs refilling.

In some embodiments, material delivery system 200 may respond to control signals based on monitoring an active processing area, as described in more detail below. For example, material delivery system 200 may be configured to increase or decrease a material feed rate in order to control characteristics of an active processing area during additive manufacturing (e.g., in a closed loop control manner), such as the height (or thickness) of the active processing area as well as the flatness of the active processing area. In such a control scheme, increasing the material flow rate (e.g., to deposition element 120) may increase the height and/or flatness of the active processing area (e.g., a melt pool in a laser metal deposition machine) and decreasing the material flow rate may decrease the height or flatness of the active processing area during manufacturing.

In some cases, flatness may be considered a macro measurement whereas thickness may be considered a voxel measurement, where a voxel is generally a value on a regular grid in three-dimensional space. Flatness of a segment (e.g., a layer) may be measured, for example, by determining a standard deviation or variance of a plurality of melt pool centroids or thickness values across the segment. Generally, flatness may be affected by powder flow rate as well as scan rate because scan rate affects the amount of powder flowing into a particular voxel over fixed period of time. In other words, when slowing down a deposition element, the amount of powder that enters the melt pool increases for a fixed powder flow rate, which makes the melt pool thicker, and vice versa.

### Active Monitoring of Active Processing Area for Closed Loop Control

FIG. 3 depicts an example of an additive manufacturing machine with an active processing area monitoring system 300 that may be configured for monitoring an active processing area (e.g., 312) and enabling closed loop control of the additive manufacturing machine to affect characteristics of the active processing area.

In the depicted example, deposition assembly 302 may generally be part of an additive manufacturing system, such as additive manufacturing system 100 described above with respect to FIG. 1, and deposition head 303 is an example of a deposition element 120, as described above with respect to FIG. 1. Note that other aspects of the additive manufacturing system are omitted for clarity.

In this example, active processing area monitoring system 300 includes a horizontal extension element 304 that is connected to deposition assembly 302 and configured to laterally extend camera 308 away from deposition assembly 302. Note that the particular point of attachment between horizontal extension element 304 and deposition assembly 302 is just one example, and many other points of attachment to aspects of an additive manufacturing system, such as to aspects of a process motion system, are possible. Further in this example, horizontal extension element 304 is configured to extend (or project) from or retract towards deposition assembly 302 in the directions indicated by arrow 316. However, in other embodiments, horizontal extension element 304 could be a fixed length extension.

Horizontal extension element 304 is also configured to rotate around axis 315, as depicted by arrows 314, in this example. Axis 315 may be generally coaxial with deposition assembly 302. This rotation allows camera 308 to be moved around the active processing area 312 and to account for possible obstructions in the manufacturing volume (e.g., within a closed additive manufacturing chamber). In other embodiments, horizontal extension element 304 may be attached to deposition assembly 302 without the ability to rotate.

Active processing area monitoring system 300 further includes a joint 319 (e.g., a hinge) connecting horizontal extension element 304 to vertical extension element 306, and allowing rotation of vertical extension element 306 relative to horizontal extension element 304, such as depicted by arrow 318. This rotation allows camera 308 to be directed at active processing area 312 at different extensions of horizontal extension element 304.

Like horizontal extension element 304, vertical extension element 306 is also configured to extend and retract, in this case along the directions of arrow 320. In other examples, vertical extension element 306 may be fixed at a given length.

Horizontal extension element 304, joint 319, and vertical extension element 306 are each generally configured to enable positioning camera 308 such that its field of view 310 encompasses active processing area 312. As described in more detail below, this allows for actively determining characteristics of active processing area 312, such as: two-dimensional area, centroid location (e.g., in terms of multiple coordinate axes), elliptic major axis, elliptic minor axis, elliptic ratio, rectangle width, rectangle height, bounding polygon location (e.g., bounding rectangle in terms of multiple coordinate axes), bounding polygon major axis (e.g., rectangle major axis), bounding polygon minor axis (e.g., rectangle minor axis), perimeter (e.g., expressed as one or more coordinates, line segments, etc.), circularity, inscribed circle radius and center location, circumscribed circle radius and center location, number of holes, flatness, temperature, temperature gradient, cooling rate, and others.

In some embodiments, one or more of the extension and rotation of horizontal extension element 304, the angle of joint 319, and the extension of vertical extension element 306, may be manually adjustable, such as by manually articulating any of these adjustment elements in the directions indicated by the arrows (e.g., 314, 316, 318, and 320) and then fixing it into place by a fixing means, such as a set screw, clamp, locking pin, friction fit, or the like. In other embodiments, any of these adjustment elements may be articulated under control of an electronic control system (not depicted), such as control system 104 of FIG. 1, or a standalone control system in communication with control system 104. For example, horizontal extension element 304 and vertical extension element 306 may be electronically, magnetically, pneumatically, or otherwise programmatically actuated based on commands received from an electronic control system, such as control system 104 of FIG. 1. Similarly, horizontal extension element 304 and vertical extension element 306 may be rotated by electronic, pneumatic, or otherwise programmatic actuation.

Beneficially, adjusting camera 308 (whether manually or automatically) provides a way to reliably and repeatedly configure the field of view for camera 308 so that characteristics of active processing area 312 (such as those described above) may be viewed and thereby determined. Because active processing area monitoring system 300 is rigidly affixed to deposition assembly 302 in this example, camera 308 moves with deposition assembly 302 as it is manipulated by, for example, a process motion system, such as 112 in FIG. 1, and thus maintains its field of view during processing.

In some embodiments, camera 308 may include a zoom capability, which may be electrical and/or optical, and which may be beneficial for setting an optimal field of view (e.g., 310) after camera 308 has been moved into position. Generally, a desirable field of view may be one that includes a clear view of the active processing area (e.g., 312). In some cases, the desired field of view may also include and at least a portion of a deposition element (e.g., 303) such that a distance between the two (e.g., a working distance) may be clearly seen and determined. Further, by keeping a portion of the deposition element within the field of view, other conditions, such as clogs, may be determined using the image data.

In some embodiments, the angle 322 of camera 308 relative to the horizon may generally be an acute angle, and in some embodiments may be set to 45 or fewer degrees of declination in order to maintain a sufficient side-on view of the active processing area 312. These are just some examples, though, and other angles (e.g., 45 or more degrees of declination) are possible.

When one or more of the positioning elements (e.g., 304, 319, and 306) of active processing area monitoring system 300 are remotely controllable (e.g., programmatically), active processing area monitoring system 300 may beneficially be programmed to provide the best field of view while also avoiding obstructions and contacts with other aspects of the additive manufacturing machine or the additive manufacturing environment, such as within an enclosure in which the additive manufacturing is taking place. For example, the extension members may be moved to avoid other parts of an additive manufacturing system, such as the enclosure, actuators, coolant and material lines, and the like, in addition to the part be manufactured.

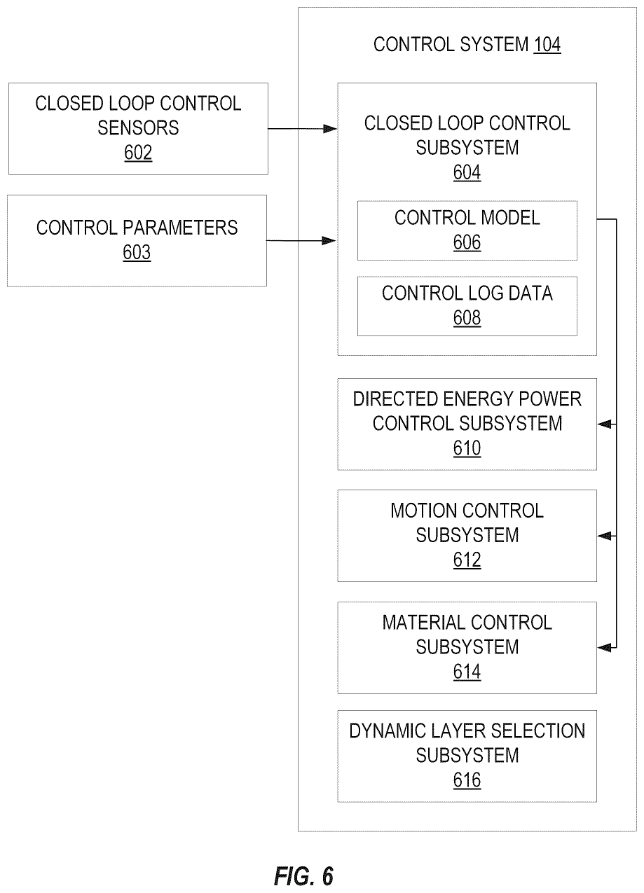

In some embodiments, camera 308 may be configured to provide image data to an electronic control system (e.g., control system 104 of FIG. 1 and FIG. 6) configured to detect and track active processing area 312, and thereafter to provide active feedback to the electronic control system to cause controllable positioning elements of active processing area monitoring system 300 to adjust to provide a suitable field of view. In some embodiments, the image data may be based on the visible light spectrum, while in others it may be based on other spectra of light, such as infrared light, or a mix of spectra. In some embodiments, camera 308 may be a depth-sensing camera configured to estimate the position of an object, such as active processing area 312, in a three-dimensional space and provide that position back to a control system, such as control system 104 of FIG. 1 and as further described with respect to FIG. 6.

In some embodiments, the location of camera 308 and angle 322 of camera 308 may be determined by the additive manufacturing system. For example, the three-dimensional coordinate location within a build volume, which may be the same volume referenced by the additive manufacturing system when building a part, may be determined based on knowing the position of deposition assembly 302, the length of the horizontal extension element 304, the length of the vertical extension element 306, and the angle 322 of the camera 308 with respect to some reference (e.g., the horizontal plane), which may match an angle of rotation of joint 319. In some embodiments, these distances and angles may be determined by precise motion encoders on each of the adjustable elements (not shown) so that when they are adjusted, whether manually or through programmatic control, updated locations and/or angles are determined by the system. With all of these locations and angles known, it is possible to determine an estimated location of the active processing area 312 in a two-or three-dimensional coordinate systems, and to determine various characteristics of active processing area 312.

Further, in another embodiment, camera 308 may include a range finding capability, such as by an integral light detection and ranging (LiDAR) sensor. Alternatively, a range-finding sensor, such as a LiDAR sensor, may be positioned with or attached to camera 308 to provide the same function. As above, in some cases, camera 308 may have inherent range-finding capability, such as in the case of a depth-sensing camera.

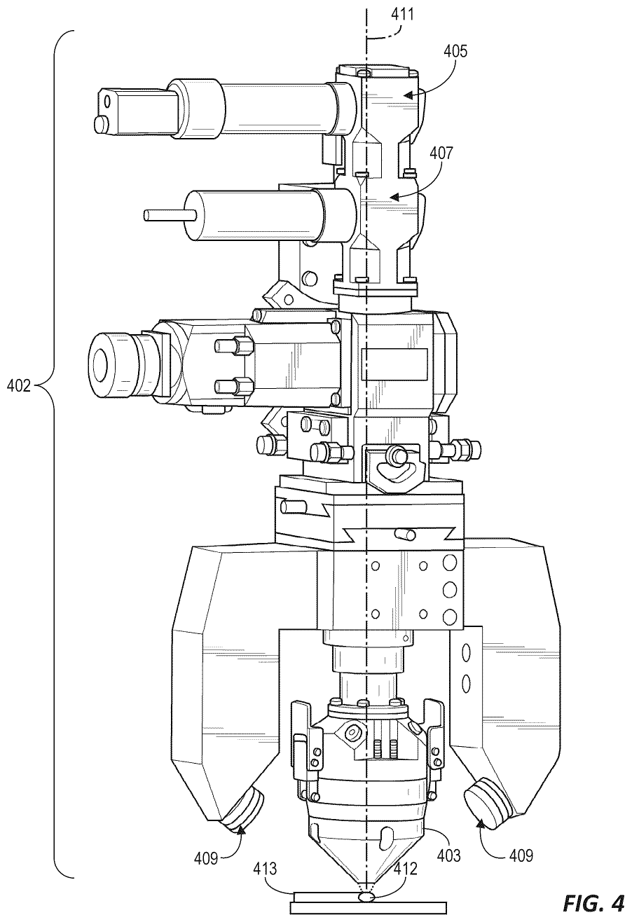

FIG. 4 depicts another example of an active processing monitoring system.

In the depicted example, deposition assembly 402 includes various sensors that enable monitoring of active processing area 412, and whose data can be used in various combinations to enable closed loop control of characteristics of active processing area 412, such as by changing operational settings of the additive manufacturing system including deposition assembly 402.

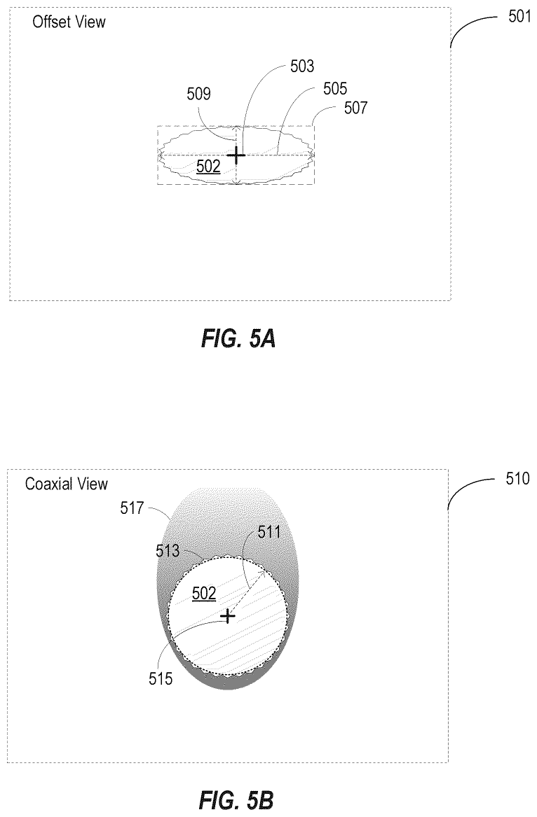

In particular, deposition assembly 402 includes coaxial active processing area image sensor 405, which is configured to capture image data from above active processing area 412 (e.g., looking down upon active processing area 412). Generally, the field of view of coaxial active processing area image sensor 405 may be aligned with (e.g., coaxial with) directed energy (e.g., laser) axis 411 of deposition assembly 402, which may be accomplished by using optical elements, such as angled mirrors and beam splitter optical elements to allow for monitoring both the melt pool temperature and width. With its look-down view of active processing area 412, coaxial active processing area image sensor 405 may be configured to determine (or to assist in the determination of) various characteristics of active processing area 412, including length, width, height, roundness or circularity, symmetry, center of mass, centroid location, area, volume, centroid, elliptic major axis, elliptic minor axis, elliptic ratio, rectangle width, rectangle height, rectangle location, perimeter, fitted rectangle major axis, fitted rectangle minor axis, inscribed circle radius, circumscribed circle radius, flatness, and number of holes, and pixel intensity or brightness, to name a few. For example, in some embodiments, coaxial active processing area image sensor 405 may be configured to measure a width (e.g., a maximum width) of active processing area 412. An example view from a coaxial active processing area image sensor, such as 405, is depicted in FIG. 5B.

In some embodiments, coaxial active processing area image sensor 405 may be a visible light or infrared-type camera sensor configured to provide image data to a control system, such as control system 104 of FIG. 1 and as further described with respect to FIG. 6.

Deposition assembly 402 further includes active processing area temperature sensor 407, which is configured to determine, for example, a temperature of active processing area 412, a temperature gradient across active processing area 412, a heating or cooling rate of active processing area 412, and the like. Active processing area temperature sensor 407 may be configured to provide temperature data to a control system, such as control system 104 of FIG. 1 and as further described with respect to FIG. 6.

In some embodiments, active processing area temperature sensor 407 may be a type if pyrometer, such as an infrared thermometer or infrared sensor, configured to measure temperature based on thermal radiance of an area, such as active processing area 412. In some cases, active processing area temperature sensor 407 may be configured to generate a heat map of a given area, including active processing area 412, which indicates heating and cooling in areas adjacent to active processing area 412, in addition to the temperature characteristics of active processing area 412. As with coaxial active processing area image sensor 405, active processing area temperature sensor 407 may be configured with a field of view or sensory reception field aligned with (e.g., coaxial with) directed energy axis 411 of deposition assembly 402, which may be accomplished by using optical elements, such as angled, multi-way mirror elements.

Deposition assembly 402 further includes offset active processing area image sensors 409, which are configured to view active processing area 412 from offset viewing angles. In this example, the physical offset of offset active processing area image sensors 409 is lateral (e.g., to the side) and vertical (e.g., above) active processing area 412. Beneficially, this physical offset allows for capturing image data of the active processing area the side (and in this example multiple sides) to determine various characteristics of active processing area 412, such as length, width, height, roundness or circularity, symmetry, center of mass, centroid location, area, volume, centroid, elliptic major axis, elliptic minor axis, elliptic ratio, rectangle width, rectangle height, rectangle location, perimeter, fitted rectangle major axis, fitted rectangle minor axis, inscribed circle radius, circumscribed circle radius, flatness, and number of holes, and pixel intensity or brightness, to name a few. For example, offset active processing area image sensors 409 may be used to determine a height (or thickness) of active processing area 412 (e.g., as measured from an underlying substrate or layer of a part, such as layer 413). An example view from an offset active processing area image sensor, such as 409, is depicted in FIG. 5A.

Note that the example of FIG. 4 includes two offset active processing area image sensors 409 horizontally opposed from each other so as to look at active processing area 412 from angles 180 degrees apart around directed energy axis 411. Beneficially, using multiple offset active processing area image sensors, such as in this example, provides for multiple views with which to determine active processing area characteristics more robustly. For example, if (as in this example) both offset active processing area image sensors 409 report “seeing” a valid active processing area, then characteristics determined by those image sensors may be combined (e.g., averaged). As another example, if only one offset active processing area image sensor is reporting valid data, then it can be used alone for determining active processing area characteristics.

Various ways of determining a valid active process area in image data are possible. For example, a region of interest (ROI) may be defined that is just below the deposition element and generally surrounding the area within which a melt pool is expected to occur. If no data is received within this region of interest, but is received outside of it, it may be determined that there is not a valid active processing area.

Another method is to determine whether a calculated area of the active processing area (e.g., a melt pool) is larger than a threshold. For example, if the calculated area is below a threshold, then an invalid active processing area may be determined, whereas if the calculated area is above the threshold, then a valid active processing area may be determined. In some embodiments, the threshold area may be based on the area of the laser spot size. For example, if the calculated area is less than the laser spot size, or some fraction of the laser spot size (e.g., 1/10th of the laser spot size), then an invalid active processing area may be determined.

In some cases, when characteristics determined based on each of offset active processing area image sensors 409 diverge, e.g., more than a threshold percentage or amount, an alert may be generated and/or a build process may be suspended. The active feedback may assist with closed loop control of the build process and in particular may improve the reliability of data being used for a closed loop control process.

In the example of FIG. 4, offset active processing area image sensors 409 are positioned in such a manner to reduce potentially harmful directed energy (e.g., laser) backscatter while providing enough angle to reliably measure certain characteristics of active processing area 412, such as height (or thickness). In other examples, the angle and position of offset active processing area image sensors 409 may be different. Further, while in FIG. 4 there are two offset active processing area image sensors 409, in other embodiments, different numbers of offset active processing area sensors may be used (e.g., one, or more than two).

In some embodiments, offset active processing area image sensors 409 may be a visible light or infrared-type camera sensor configured to provide image data to a control system, such as control system 104 of FIG. 1 and as further described with respect to FIG. 6. Further, offset active processing area image sensor 409 may include filters to improve the view of active processing area 412, such as to filter out backscattered laser light, glare, and other types image artifacts that may obscure the view of active processing area 412 or damage the image sensor. For example, infrared (IR) and ultraviolet (UV) filters and polarizers may be used. In the case where the laser wavelength is not in the IR range, a filter may be used to eliminate the laser light from being picked up by any image sensor. So, for example, when using a blue laser, a 450 nm wavelength filter may be used. When using an IR laser, 1070 nm or 980 nm filters may be used based on the IR laser's specific wavelength.

Generally, one or more of, including various combinations of, coaxial active processing area image sensor 405, active processing area temperature sensor 407, and/or offset active processing area image sensors 409 may be used to perform closed loop control of an additive manufacturing process, and in particular closed loop control of characteristics of the active processing area (e.g., 412) generated by an additive manufacturing process. Various operational settings (alternatively referred to as processing parameters) of an additive manufacturing process may be beneficially controlled with reference to data generated by the aforementioned sensors, which may be referred to collectively as closed loop control sensors. Examples of various closed loop control schema are described further below with respect to FIG. 6.

### Example Active Processing Area Image Data for Characteristic Determination

FIGS. 5A and 5B depict example views of an active processing area (e.g., 412 of FIG. 4) that may be used for determining characteristics of the active processing area for closed loop control. Image data such as that depicted in FIGS. 5A and 5B may be generated by closed loop control sensors, such as coaxial active processing area image sensor 405, active processing area temperature sensor 407, and/or offset active processing area image sensors 409 described above with respect to FIG. 4.

In particular, FIG. 5A depicts an example offset view 501 of active processing area 502, such as may be generated by one of the offset active processing area image sensors 409 of FIG. 4. As described above, various characteristics of active processing area determined based on the image data, including centroid 503, major axis 505, minor axis 509, and bounding rectangle 507. Note that these are just a few examples, and others are possible. In some cases, a height (or thickness) of active processing area 502 may be based on a length of minor axis 509 or a dimension of bounding rectangle 507 or some combination. In some cases, a known position (e.g., coordinate position and angle) of the offset active processing area image sensor may be used to estimate the height (or thickness) of active processing area 502 trigonometrically, or based on another function modeling the relationship of the depicted two-dimensional geometry of active processing area 502 and a three-dimensional coordinate, such as height (or thickness). Further, a height of active processing area 502 may be determined based on a working distance between, for example, a deposition element and the active processing area and a known height (e.g., z-axis position) of the deposition element.

FIG. 5B depicts an example coaxial view 510 of active processing area 502, such as may be generated by coaxial active processing area image sensors 405 of FIG. 4. As described above, various characteristics of active processing area determined based on the image data, including centroid 515, inscribed circle radius 511, roundness (e.g., based on a comparison of the border of active processing area 502 with inscribed circle circumference 513), and others. Further, coaxial view 510 depicts a heat gradient 517 around active processing area 502, which might be produced as active processing area 502 is scanned downward across coaxial view 510. Note that these are just a few examples, and others are possible.

### Example Closed Loop Control System

FIG. 6 depicts aspects of control system 104 of FIG. 1 configured for performing closed loop control of an additive manufacturing process, and in particular for controlling characteristics of an active processing area, such as those described above.

In this example, control system 104 includes closed loop control subsystem 604 configured to receive closed loop control sensor data from closed loop control sensors 602. Examples of closed loop control sensors include coaxial active processing area image sensor 405, active processing area temperature sensor 407, and/or offset active processing area image sensors 409 of FIG. 4 as well as sensors 114 and 116 of FIG. 1.

Generally, closed loop control subsystem 604 processes sensor data from closed loop control sensors 602 in order to control various aspects of an additive manufacturing system, such as by determining operational settings for the various aspects. For example, in FIG. 6, closed loop control subsystem 604 is configured to determine characteristics of an active processing area and compare them to control parameters 603 (e.g., user-defined control parameters). Generally, control parameters 603 may relate to target or desired values for various characteristics of an active processing area as described above.

As an example, closed loop control of a width or size of an active processing area (e.g., a melt pool) may be controlled by modulating a directed energy power level (e.g., laser power level) via directed energy power control subsystem 610 and monitoring the change to the active processing area via closed loop control sensors 602. In some cases, modulating the directed energy power level may involve pulsing the laser on and off at a determined frequency and/or with specific on and off durations in order to modulate the average laser power delivered to an active processing area. For example, increasing directed energy power may generally increase the width or size of an active processing area as more material is melted and accumulated in the active processing area and decreasing directed energy power may generally decrease the width or size of the active processing area as less material is melted and accumulated in the active processing area. Thus, if the measured width or size of the active processing area is below a target width or size, a directed energy power may be increased via directed energy power control subsystem 610 in order to increase the width or size of the active processing area to the target value as set in control parameters 603. Conversely, if the measured width or size of the active processing area is above a target width or size, the directed energy power may be decreased via directed energy power control subsystem 610 in order to decrease the width or size of the active processing area to the target value as set in control parameters 603.

As another example, closed loop control of the height (or thickness) or flatness of an active processing area may be controlled by modulating a scan rate of a deposition element (e.g., 403 in FIG. 4) via motion control subsystem 612 and monitoring the change to the active processing area via the closed loop control sensors 602. For example, decreasing scan rate may generally increase the height (or thickness) of an active processing area as more material is melted and accumulated in the active processing area and increasing scan rate may generally decrease the height (or thickness) of active processing area as less material is melted and accumulated in the active processing area. Thus, if the measured thickness of an active processing area (e.g., a melt pool) is below a target thickness, a scan rate may be decreased via motion control subsystem 612 in order to accumulate more material during processing and thereby increase the thickness of the active processing area to the target value as set in control parameters 603. Conversely, if the measured thickness of the active processing area is above a target thickness, a scan rate may be increased via motion control subsystem 612 in order to accumulate less material during processing and thereby decrease the thickness of the active processing area to the target value as set in control parameters 603.

As another example, closed loop control of the height (or thickness) or flatness of an active processing area may be controlled by modulating a material feed rate via material control subsystem 614 and monitoring the change to active processing area via the closed loop control sensors 602. For example, increasing the material feed rate may generally increase the height (or thickness) of an active processing area as more material is melted and accumulated in the active processing area and decreasing material feed rate may generally decrease the height (or thickness) of the active processing area as less material is melted and accumulated in the active processing area. Thus, if the measured thickness of an active processing area (e.g., a melt pool) is below a target thickness, a material feed rate may be increased via material control subsystem 614 in order to accumulate more material during processing and thereby increase the thickness of the active processing area to the target value as set in control parameters 603. Conversely, if the measured thickness of the active processing area is above a target thickness, the material feed rate may be decreased via material control subsystem 614 in order to accumulate less material during processing and thereby decrease the thickness of the active processing area to the target value as set in control parameters 603.

As another example, closed loop control of the temperature, heating rate, cooling rate, heat distribution (or map), or the like of active processing area 412 may be controlled by modulating the directed energy power level and monitoring the change to the active processing area via closed loop control sensors 602. For example, increasing the directed energy power level may generally increase the temperature of an active processing area decreasing directed energy power level may generally decrease the temperature of the active processing area. Thus, if the measured temperature of an active processing area (e.g., a melt pool) is below a target temperature, a directed energy power level be increased via directed energy power control subsystem 610 in order to increase temperature to the target value as set in control parameters 603. Conversely, if the measured temperature of the active processing area is above a target temperature, the directed energy power level may be decreased via directed energy power control subsystem 610 in order to decrease the temperature of the active processing area to the target value as set in control parameters 603.

Beneficially, characteristics of an active processing area (e.g., height (or thickness)) determined by closed loop control sensors 602, such as one or more of those described above, may also provide a reference for the current height of the part being built (e.g., a built layer height), which may improve layer selection for a next layer to be built, for example, such as in the case of an active layer selection system as described in U.S. Pat. No. 10,569,522, entitled “Dynamic Layer Selection In Additive Manufacturing Using Sensor Feedback”, which is incorporated by reference herein in its entirety. For example, dynamic layer selection subsystem 616 may use data from closed loop control sensors 602 to determine a current layer height and to select the best next layer for building based on the current layer height.

In some embodiments, closed loop control subsystem 604 may implement control model 606, such as a machine learning model, to improve control of operational systems of an additive manufacturing system, such as directed energy power control subsystem 610, scan rate via motion control subsystem 612, and material feed rate via material control subsystem 614. For example, control model 606 may process closed loop control data from closed loop control sensors 602 (as well as other sensors of the additive manufacturing system) and predict operational settings for the operational systems. In this way, control model 606 may help smooth transitions between current and new operational settings and avoid over and underruns of target values, such as set by control parameters 603, as well as oscillations of operational settings caused by overly active closed loop control.

Control model 606 may be trained based on control log data 608 collected during an additive manufacturing process, which may include, for example, the target values for characteristics of an active processing area (e.g., as set by control parameters 603) and the actual values measured by closed loop control sensors 602. In some cases, control model 606 may be configured to learn “online” such that control model 606 is updated while in use based on data generated by an additive manufacturing process. In other cases, control model 606 may be trained “offline” and deployed as a static model for use by closed loop control subsystem 604.

Control log data 608 may further be used to refine an additive manufacturing process even when control model 606 is not used. For example, a beneficial output of intervention by closed loop control subsystem 604 is a set of operational parameters that best met the objectives (e.g., determined by control parameters 603) of an additive manufacturing process. Example objectives include a target layer height and layer height deviation over an entire layer. These operational parameters may then be incorporated into a build file (e.g., into machine control code such as G-code) for a subsequent build. Then, as subsequent builds of the same part refine the build file, closed loop control subsystem 604 may have to intervene less often and/or less significantly. Thus, in addition to enabling better online control of the additive manufacturing process, closed loop control subsystem 604 may improve the offline adaptation of build files.

Note that while this example describes controlling directed energy power via directed energy power control subsystem 610, scan rate via motion control subsystem 612, and material feed rate via material control subsystem 614, control system 104 may further control other aspects of an additive manufacturing system based on closed loop control sensors 602, including a gas delivery system (e.g., 110 in FIG. 1), a cooling system (e.g., 132 in FIG. 1), and others as described herein.

### Example Method of Additive Manufacturing With a Closed Loop Control System

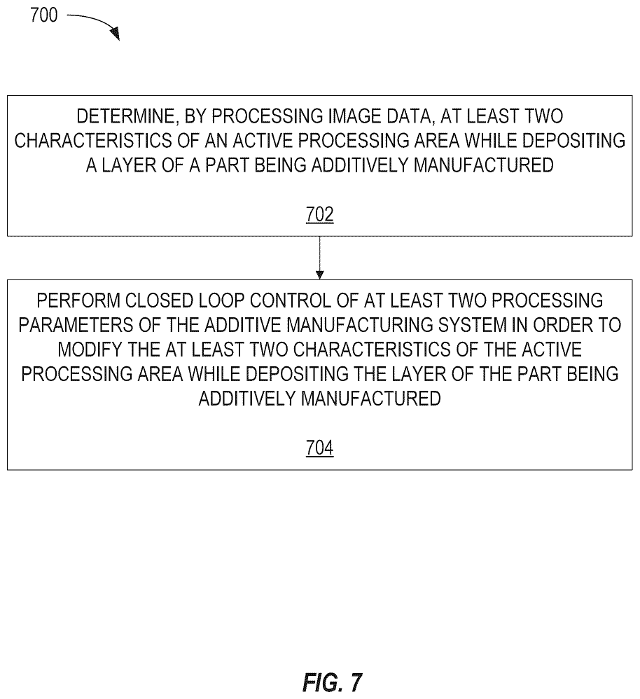

FIG. 7 depicts an example method 700 of operating an additive manufacturing system, such as those depicted and described herein, including with respect to FIGS. 1-4 and 6. For example, method 700 may be performed by or in conjunction with an active processing area monitoring system, such as described above.

Method 700 beings at step 702 with determining, by processing image data, at least two characteristics of an active processing area while depositing a layer of a part being additively manufactured. For example, the image data may be generated by one or more of coaxial active processing area image sensor 405, active processing area temperature sensor 407, and/or offset active processing area image sensors 409 described above with respect to FIG. 4.

Method 700 then proceeds to step 704 with performing closed loop control of at least two processing parameters of the additive manufacturing system in order to modify the at least two characteristics of the active processing area while depositing the layer of the part being additively manufactured. In some embodiments, step 704 is performed by a control system, such as control system 104 of FIGS. 1 and 6.

In some embodiments, a first characteristic of the at least two characteristics of the active processing area is a height of the active processing area, a first processing parameter of the at least two processing parameters of the additive manufacturing system is a scan rate of a deposition element of the additive manufacturing system, the scan rate of the deposition element is configured to control, at least in part, the height of the active processing area, a second processing parameter of the at least two processing parameters of the additive manufacturing system is a power level of a directed energy element of the additive manufacturing system, a second characteristic of the at least two characteristics of the active processing area is a width of the active processing area, and the power level of the directed energy element is configured to control, at least in part, the width of the active processing area.

In some embodiments, a first characteristic of the at least two characteristics of the active processing area is a height of the active processing area, a first processing parameter of the at least two processing parameters of the additive manufacturing system is a scan rate of a deposition element of the additive manufacturing system, the scan rate of the deposition element is configured to control, at least in part, the height of the active processing area, a second processing parameter of the at least two processing parameters of the additive manufacturing system is a power level of a directed energy element of the additive manufacturing system, a second characteristic of the at least two characteristics of the active processing area is a temperature of the active processing area, and the power level of the directed energy element is configured to control, at least in part, the temperature of the active processing area.

In some embodiments, a first characteristic of the at least two characteristics of the active processing area is a height of the active processing area, a first processing parameter of the at least two processing parameters of the additive manufacturing system is a material feed rate of the additive manufacturing system, the material feed rate of the deposition element is configured to control, at least in part, the height of the active processing area, a second processing parameter of the at least two processing parameters of the additive manufacturing system is a power level of a directed energy element of the additive manufacturing system, a second characteristic of the at least two characteristics of the active processing area is a width of the active processing area, and the power level of the directed energy element is configured to control, at least in part, the width of the active processing area.

In some embodiments, a first characteristic of the at least two characteristics of the active processing area is a height of the active processing area, a first processing parameter of the at least two processing parameters of the additive manufacturing system is a material feed rate of a deposition element of the additive manufacturing system, the material feed rate of the deposition element is configured to control, at least in part, the height of the active processing area, a second processing parameter of the at least two processing parameters of the additive manufacturing system is a power level of a directed energy element of the additive manufacturing system, a second characteristic of the at least two characteristics of the active processing area is a temperature of the active processing area, and the power level of the directed energy element is configured to control, at least in part, the temperature of the active processing area.

In some embodiments, a first characteristic of the at least two characteristics of the active processing area is a height of the active processing area, a first processing parameter of the at least two processing parameters of the additive manufacturing system is a material feed rate of a deposition element of the additive manufacturing system, the material feed rate of the deposition element is configured to control, at least in part, the height of the active processing area, a second processing parameter of the at least two processing parameters of the additive manufacturing system is a power level of a directed energy element of the additive manufacturing system, a second characteristic of the at least two characteristics of the active processing area is a cooling rate of the active processing area, and the power level of the directed energy element is configured to control, at least in part, the cooling rate of the active processing area.

In some embodiments, performing closed loop control of the at least two processing parameters comprises: determining a current value for each of the at least two characteristics of the active processing area; determining a desired value for each of the at least two characteristics of the active processing area; and modifying each of the at least two processing parameters to achieve the desired value for each of the at least two characteristics of the active processing area. In some embodiments, the current value for each of the at least two characteristics of the active processing area are determined based on closed loop control sensors, such as closed loop control sensors 602 of FIG. 6. In some embodiments, the desired value for each of the at least two characteristics of the active processing area are determined based on control parameters or settings, such as control parameters 603 of FIG. 6. In some embodiments, modifying each of the at least two processing parameters to achieve the desired value for each of the at least two characteristics of the active processing area is performed by closed loop control subsystem 604 of FIG. 6.

In some embodiments, modifying each of the at least two processing parameters comprises: providing the current value for each of the at least two characteristics of the active processing area and the desired value for each of the at least two characteristics of the active processing area to a machine learning model; and receiving, from the machine learning model, set points for the at least two processing parameters. In some embodiments, the machine learning model is control model 606 of FIG. 6.

In some embodiments, method 700 further includes: receiving a first subset of the image data from a first camera laterally and vertically offset from the active processing area; determining a location of the active processing area based on the first subset of image data; receiving a second subset of the image data from a second camera vertically offset from the active processing area and having a field of view coaxial with a deposition element of the additive manufacturing system; and determining a width of the active processing area based on the second subset of image data. In some embodiments, the first camera laterally and vertically offset from the active processing area is one of offset active processing area image sensors 409 of FIG. 4. In some embodiments, the second camera vertically offset from the active processing area is coaxial active processing area image sensor 405 of FIG. 4.

In some embodiments, method 700 further includes receiving a third subset of the image data from a third camera laterally and vertically offset from the active processing area and laterally offset from the first camera. In some embodiments, the third camera laterally and vertically offset from the active processing area is one of offset active processing area image sensors 409 of FIG. 4.

In some embodiments, the first camera comprises a filter configured to reduce image artifacts from the active processing area.

In some embodiments, method 700 further includes measuring a temperature of the active processing area comprises using one or more pyrometers. In some embodiments, the one or more pyrometers include active processing area temperature sensor 407 of FIG. 4.

In some embodiments, method 700 further includes measuring a cooling rate of the active processing area using one or more infrared cameras, such as, for example, active processing area temperature sensor 407. In other embodiments, cooling rate may be determined based on visible light sensors, such as active processing area image sensor 405 and offset active processing area image sensors 409, either independently, or in conjunction with active processing area temperature sensor 407.

In some embodiments, method 700 further includes selecting a subsequent layer of the part being additively manufactured based on at least one of the at least two characteristics of the active processing area. In some embodiments, selecting a subsequent layer of the part being additively manufactured is performed by dynamic layer selection subsystem 616 of FIG. 6.

In some embodiments, method 700 further includes: logging as operational data the at least two processing parameters of the additive manufacturing system and the at least two characteristics of the active processing area; and training a machine learning model to predict the at least two characteristics of the active processing area based on the at least two processing parameters of the additive manufacturing system. In some examples, the logged operational data is control log data 608 of FIG. 6. In some embodiments, the machine learning model is control model 606 of FIG. 6.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of operating an additive manufacturing system, comprising:
determining, by processing image data, at least two characteristics of an active processing area while depositing a layer of a part being additively manufactured; and
performing closed loop control of at least two processing parameters of the additive manufacturing system in order to modify the at least two characteristics of the active processing area while depositing the layer of the part being additively manufactured.

2. The method of claim 1, wherein:
a first characteristic of the at least two characteristics of the active processing area is a height of the active processing area,
a first processing parameter of the at least two processing parameters of the additive manufacturing system is a scan rate of a deposition element of the additive manufacturing system,
the scan rate of the deposition element is configured to control, at least in part, the height of the active processing area,
a second processing parameter of the at least two processing parameters of the additive manufacturing system is a power level of a directed energy element of the additive manufacturing system,
a second characteristic of the at least two characteristics of the active processing area is a width of the active processing area, and
the power level of the directed energy element is configured to control, at least in part, the width of the active processing area.

3. The method of claim 1, wherein:
a first characteristic of the at least two characteristics of the active processing area is a height of the active processing area,
a first processing parameter of the at least two processing parameters of the additive manufacturing system is a scan rate of a deposition element of the additive manufacturing system,
the scan rate of the deposition element is configured to control, at least in part, the height of the active processing area,
a second processing parameter of the at least two processing parameters of the additive manufacturing system is a power level of a directed energy element of the additive manufacturing system,
a second characteristic of the at least two characteristics of the active processing area is a temperature of the active processing area, and
the power level of the directed energy element is configured to control, at least in part, the temperature of the active processing area.

4. The method of claim 1, wherein:
a first characteristic of the at least two characteristics of the active processing area is a height of the active processing area,
a first processing parameter of the at least two processing parameters of the additive manufacturing system is a material feed rate of the additive manufacturing system,
the material feed rate of the deposition element is configured to control, at least in part, the height of the active processing area,
a second processing parameter of the at least two processing parameters of the additive manufacturing system is a power level of a directed energy element of the additive manufacturing system,
a second characteristic of the at least two characteristics of the active processing area is a width of the active processing area, and
the power level of the directed energy element is configured to control, at least in part, the width of the active processing area.

5. The method of claim 1, wherein:
a first characteristic of the at least two characteristics of the active processing area is a height of the active processing area,
a first processing parameter of the at least two processing parameters of the additive manufacturing system is a material feed rate of a deposition element of the additive manufacturing system,
the material feed rate of the deposition element is configured to control, at least in part, the height of the active processing area,
a second processing parameter of the at least two processing parameters of the additive manufacturing system is a power level of a directed energy element of the additive manufacturing system,
a second characteristic of the at least two characteristics of the active processing area is a temperature of the active processing area, and
the power level of the directed energy element is configured to control, at least in part, the temperature of the active processing area.

6. The method of claim 1, wherein:
a first characteristic of the at least two characteristics of the active processing area is a height of the active processing area,
a first processing parameter of the at least two processing parameters of the additive manufacturing system is a material feed rate of a deposition element of the additive manufacturing system,
the material feed rate of the deposition element is configured to control, at least in part, the height of the active processing area,
a second processing parameter of the at least two processing parameters of the additive manufacturing system is a power level of a directed energy element of the additive manufacturing system,
a second characteristic of the at least two characteristics of the active processing area is a cooling rate of the active processing area, and
the power level of the directed energy element is configured to control, at least in part, the cooling rate of the active processing area.

7. The method of claim 1, wherein performing closed loop control of the at least two processing parameters comprises:
determining a current value for each of the at least two characteristics of the active processing area;
determining a desired value for each of the at least two characteristics of the active processing area; and
modifying each of the at least two processing parameters to achieve the desired value for each of the at least two characteristics of the active processing area.

8. The method of claim 7, wherein modifying each of the at least two processing parameters comprises:
providing the current value for each of the at least two characteristics of the active processing area and the desired value for each of the at least two characteristics of the active processing area to a machine learning model; and
receiving, from the machine learning model, set points for the at least two processing parameters.

9. The method of claim 1, further comprising:
receiving a first subset of the image data from a first camera laterally and vertically offset from the active processing area;
determining a location of the active processing area based on the first subset of image data;
receiving a second subset of the image data from a second camera vertically offset from the active processing area and having a field of view coaxial with a deposition element of the additive manufacturing system; and
determining a width of the active processing area based on the second subset of image data.

10. The method of claim 9, further comprising receiving a third subset of the image data from a third camera laterally and vertically offset from the active processing area and laterally offset from the first camera.

11. The method of claim 9, wherein the first camera comprises a filter configured to reduce image artifacts from the active processing area.

12. The method of claim 1, further comprising measuring a temperature of the active processing area comprises using one or more pyrometers.

13. The method of claim 1, further comprising measuring a cooling rate of the active processing area using one or more infrared cameras.

14. The method of claim 1, further comprising selecting a subsequent layer of the part being additively manufactured based on at least one of the at least two characteristics of the active processing area.

15. The method of claim 1, further comprising:
logging as operational data the at least two processing parameters of the additive manufacturing system and the at least two characteristics of the active processing area; and
training a machine learning model to predict the at least two characteristics of the active processing area based on he at least two processing parameters of the additive manufacturing system.

16. A processing system, comprising: a memory comprising computer-executable instructions; and a processor configured to execute the computer-executable instructions and cause the processing system to:
determine, by processing image data, at least two characteristics of an active processing area while depositing a layer of a part being additively manufactured; and
perform closed loop control of at least two processing parameters of the additive manufacturing system in order to modify the at least two characteristics of the active processing area while depositing the layer of the part being additively manufactured.
